(19) United States
(12) Patent Application Publication
(10) Pub. No.: US 2025/0360699 A1
(43) Pub. Date: Nov. 27, 2025

(54) MULTIWALL PAPER-BASED PACKAGING STRUCTURES

(71) Applicant: PROAMPAC HOLDINGS INC., Cincinnati, OH (US)

(72) Inventors: Raymond J. Recchia, Cincinnati, OH (US); Amir Saffar, Laval (CA); Seyed Hesamoddin Tabatabaei, Mason, OH (US)

(21) Appl. No.: 19/217,661

(22) Filed: May 23, 2025

Related U.S. Application Data
(60) Provisional application No. 63/651,474, filed on May 24, 2024.

(51) Int. Cl. B32B 27/10; B31B 70/26; B32B 7/14; B32B 29/06; B32B 37/12; B32B 37/24; B65D 30/08; B65D 30/20

(52) U.S. Cl. CPC B32B 27/10; B31B 70/26; B32B 7/14; B32B 29/06; B32B 37/1292; B32B 37/24; B65D 31/02; B65D 31/10; B32B 2037/243; B32B 2250/03; B32B 2255/10; B32B 2255/12; B32B 2255/20; B32B 2255/26; B32B 2255/28; B32B 2307/7265; B32B 2307/75; B32B 2317/12; B32B 2439/46; B32B 2439/70

(57) ABSTRACT

A paper-based packaging structure comprises an outer paper ply, a first intermediate paper ply, and an inner polymer film ply. A first adhesive layer secures the inner polymer film ply to the intermediate paper ply. A second adhesive layer secures the intermediate paper ply to the outer paper ply. The outer paper ply, the intermediate paper ply, and the inner polymer film ply are adjoined to form a multiwall structure wherein the paper-based packaging structure comprises cellulosic fiber in the range of from about 80% to about 99% by weight. In further aspects methods of forming the packaging structure and packaging articles are provided. In a further aspect, a packaging article formed of the packaging structure is provided.

### CROSS-REFERENCE TO RELATED APPLICATION

This application claims the priority benefit of U.S. Provisional Patent Application No. 63/651,474 filed May 24, 2024. The aforementioned application is incorporated herein by reference in its entirety.

### INCORPORATION BY REFERENCE

This application is related to U.S. provisional application Ser. No. 18/381,861filed May 7, 2024, and U.S. application Ser. No. 17/953,647 filed Sep. 27, 2022. Each of the aforementioned applications is incorporated herein by reference in its entirety.

### BACKGROUND

The present invention relates to multiwall, paper-based packaging structures and, in particular, to multiwall paper-based packaging structures that are oil and/or grease resistant, recyclable, and free of fluorochemicals.

Packaging structures having high oil/grease resistance are used for packaging contents having a high oil or grease content in order to prevent oil and/or grease from bleeding through the packaging material and staining the outer portion of the bag. To provide oil/grease resistance and prevent edge wicking, multiwall paper packaging commonly utilizes paper that contain fluorochemicals, such as per-and polyfluoroalkyl substances (PFAS), which have been deemed hazardous. Such paper is generally used as the outer print ply in these packages. In current technologies, a polymer liner, such as an oriented polypropylene (OPP) or other plastic liner that is in direct contact with the packaged product may be used to prevent oil/grease from seeping out. However, composite materials containing polymer components in excess of certain thresholds are unsuitable for recycling alongside traditional paper materials in paper recycling streams. In addition, instances of dropping or rough handling, such polymer liner may encounter pinholes or punctures, facilitating seepage of oil or grease through to the outer surface of the bag, leading to unsightly staining of the packaging exterior. The present disclosure contemplates new and improved multiwall paper-based packaging structures and methods which overcome the above-referenced problems and others.

### SUMMARY

In one aspect, a paper-based packaging structure comprises an outer paper ply, a first intermediate paper ply, and an inner polymer film ply. A first adhesive layer is disposed between the inner polymer film ply and the intermediate paper ply and secures the inner polymer film ply to the intermediate paper ply. A second adhesive layer is disposed between the intermediate paper ply and the outer paper ply and secures the intermediate paper ply to the outer paper ply. The outer paper ply, the intermediate paper ply, and the inner polymer film ply are adjoined to form a multiwall structure wherein the paper-based packaging structure comprises cellulosic fiber in the range of from about 80% to about 99% by weight. In another aspect a method of forming the packaging structure is provided. In a further aspect, a packaging article formed of the packaging structure is provided. In another aspect a method of forming the packaging article is provided.

One advantage of the present development resides in its excellent levels of oil and/or grease resistance and prevention of edge wicking.

Another advantage of the present development is found in that paper containing PFAS chemicals is not required.

Yet another advantage of the present development is the packaging structures herein are recyclable in paper recycle streams.

Another advantage is that grease migration from the interior to the outer paper layer is prevented or reduced by the presence of an intermediate grease resistant paper in the event of pinholes or other perforations in the inner polymer film ply, e.g., due to dropping or other rough handling

Still further advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings, which are not necessarily to scale, are only for purposes of illustrating preferred embodiments and are not to be construed as limiting the invention.

FIG. 1A is an isometric view of an exemplary multiwall packaging structure of the present invention, taken generally from the front.

FIG. 1B is an isometric view of the multiwall packaging structure of FIG. 1A, taken generally from the rear.

FIG. 2 is an isometric view of the multiwall packaging structure of FIG. 1A, after filling and sealing.

FIG. 3A is a side cross-sectional view of an exemplary first embodiment multiwall packaging material.

FIG. 3B is a side cross-sectional view of an exemplary second embodiment multiwall packaging material.

FIG. 3C is a side cross-sectional view of an exemplary third embodiment multiwall packaging material.

FIG. 4A is a side cross-sectional view of an exemplary fourth embodiment multiwall packaging material.

FIG. 4B is a side cross-sectional view of an exemplary fifth embodiment multiwall packaging material.

FIG. 4C is a side cross-sectional view of an exemplary sixth embodiment multiwall packaging material.

FIG. 5A is a side cross-sectional view of an exemplary seventh embodiment multiwall packaging material.

FIG. 5B is a side cross-sectional view of an exemplary eighth embodiment multiwall packaging material.

FIG. 5C is a side cross-sectional view of an exemplary ninth embodiment multiwall packaging material.

FIG. 6 is an exploded view of the rear panel illustrating a conventional adhesive dot pattern for securing the plies in a conventional oil/grease resistant multiwall bag.

FIG. 7 is an exploded view of the rear panel illustrating a first exemplary adhesive dot pattern for adhesively securing adjacent pairs of plies in the multiwall packaging structure of FIG. 1A.

FIG. 8 is an exploded view of the rear panel illustrating a second exemplary adhesive dot pattern for adhesively securing adjacent pairs of plies in the multiwall packaging structure of FIG. 1A.

FIG. 9 is an exploded view of the rear panel illustrating a third exemplary adhesive dot pattern for adhesively securing adjacent pairs of plies in the multiwall packaging structure of FIG. 1A.

FIG. 10 is a cross-sectional view of a coated paper ply which can be utilized as a standalone coated paper substrate and which can be used independently of the multilayer structures herein.

### DETAILED DESCRIPTION OF THE PREFERRED EMBODIMENTS

The terms “a” or “an,” as used herein, are defined as one or more than one. The term “another,” as used herein, is defined as at least a second or more. The terms “including” and/or “having” as used herein, are defined as comprising (i.e., open transition). As used herein, the terms “joined,” “coupled,” “operatively coupled,” and the like, are defined as indirectly or directly connected, unless specifically stated otherwise.

As used herein, “paper-based” means a material or structure primarily comprising cellulosic fibers, e.g., derived from wood pulp, and wherein the amount of plastic materials, such as polyethylene, nylon, polypropylene, polyester, and others, are sufficiently low so as not to impede recyclability in paper recycling streams.

As used herein, “recyclable” may refer to a product that is eligible for acceptance into paper recycling programs, including curbside collection programs and recycling programs that use drop-off locations, including products that comply with one or more promulgated standards or guidelines for recyclability, and including materials that are sufficiently free of plastic materials, such as polyethylene, nylon, polypropylene, polyester, and others which would impede recyclability.

As used herein, “repulpable” may refer to a product that can be reused or remade into paper (e.g., at a paper mill), including products that comply with one or more promulgated standards or guidelines for repulpability, and including materials that are sufficiently free of plastic materials, such as polyethylene, nylon, polypropylene, polyester, and others which would impede repulpability.

As used herein, the term “grease-resistant paper” may refer to paper or paper-based material that exhibits the property of inhibiting or preventing the absorption or transmission of grease or oil to a significant degree. This characteristic helps prevent undesirable staining or damage to the packaging structures herein caused by these substances.

As used herein, the term “printable paper” may refer to paper or paper-based material that is suited for accepting and retaining printed images, text, or graphics. Printable paper is characterized by its ability to effectively interact with one or more printing processes, including gravure, flexographic, lithographic, inkjet, laser, offset, and digital printing technologies. In certain embodiments, printable paper may include surface coatings, additives, or treatments that enhance ink adhesion, color vibrancy, and image resolution. In certain embodiments, printable paper may exhibit properties such as smoothness, brightness, opacity, and dimensional stability to enhance the quality and appearance of the printed image.

All numbers herein are assumed to be modified by the term “about,” unless stated otherwise. The recitation of numerical ranges by endpoints includes all numbers subsumed within that range (e.g., 1 to 5 includes, inter alia, 1, 1.5, 2, 2.75, 3, 3.80, 4, and 5).

Accordingly, unless indicated to the contrary, the numerical parameters set forth in the present specification and attached claims are approximations that can vary depending upon the desired properties sought to be obtained by the presently disclosed subject matter.

As used herein, the term “about,” when referring to a value can encompass variations of, in some embodiments ±20%, in some embodiments ±10%, in some embodiments ±5%, in some embodiments ±1%, in some embodiments ±0.5%, in some embodiments ±0.1%, and in some embodiments to ±0.01%, from the specified amount, as such variations are appropriate in the disclosed materials and methods. All compositional percentages used herein are presented on a “by weight” basis,

unless specifically stated otherwise. All basis weights herein are pounds per 3000 square foot ream unless specifically stated otherwise.

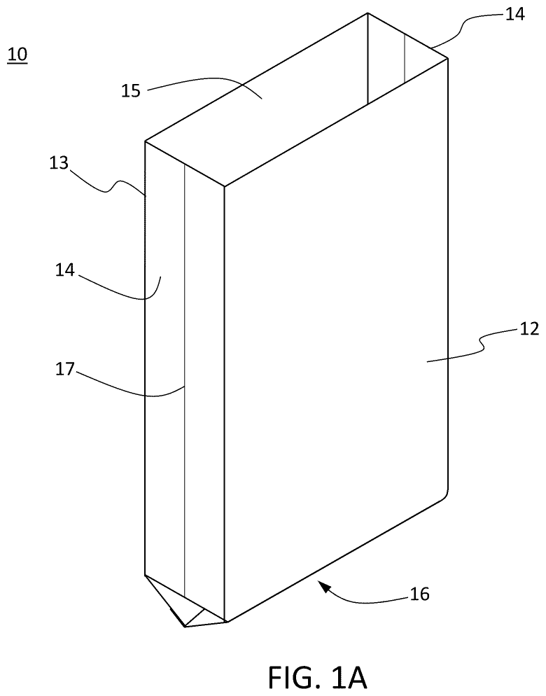

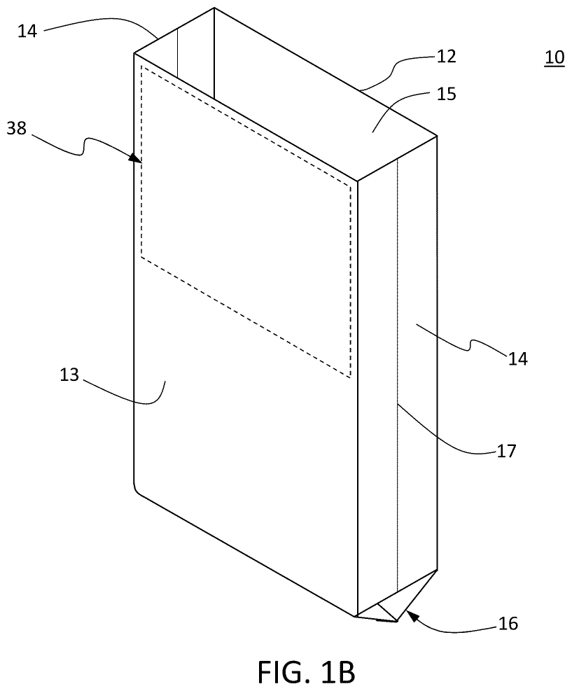

Referring now to the drawings, wherein like reference numerals are used to describe like or analogous items, FIGS. 1A and 1B illustrate an exemplary multiwall packaging article, designated generally as 10. The illustrated embodiment is a gusseted pinch bottom open mouth (PBOM) bag construction. It will be recognized that other bag constructions are also contemplated, such as self-opening sacks (SOS), sewn open mouth (SOM) bags, satchel bottom open mouth (Webb pinch) bags, and others. The multiwall packaging structures herein are advantageously formed into packages for consumable products, such as pet food and the like.

The article 10 includes a pair of generally opposing front and back panels 12 and 13, respectively. The front panel 12 and the back panel 13 are joined at opposite edges by opposing side panels 14. Prior to filling, the upper edges of the front panel 12, rear panel 13, and opposing side panels 14 define an opening 15 at the upper end of the article 10. The front, rear, and side panels may include printing, labels, or the like, e.g., containing branding and other indicia. A closed bottom 16 is formed at the bottom of the article 10. Although a pinch bottom closure 16 is illustrated, it will be recognized that other types of bottoms, such as block bottoms, and others, are contemplated. The illustrated embodiment is shown with gusseted side panels having a center fold line 17 which is folded to form a pleat allowing the article 10 to be folded flat for shipping and storage and to provide expansion space when filled. In alternative embodiments, the article 10 is a non-gusseted PBOM bag.

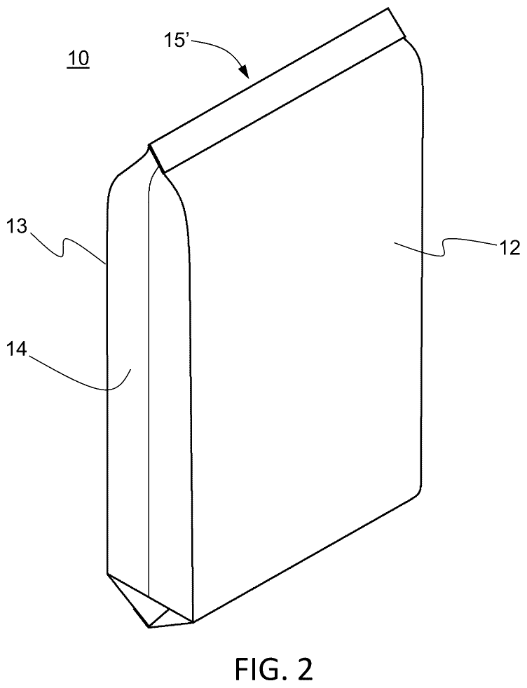

Referring now to FIG. 2, the article 10 is shown after filling, wherein the top of the bag includes a top closure 15′. In embodiments, the top closure 15′ is formed by folding and sealing the top portion of the bag 10. In embodiments, the top closure may include a sewn seam.

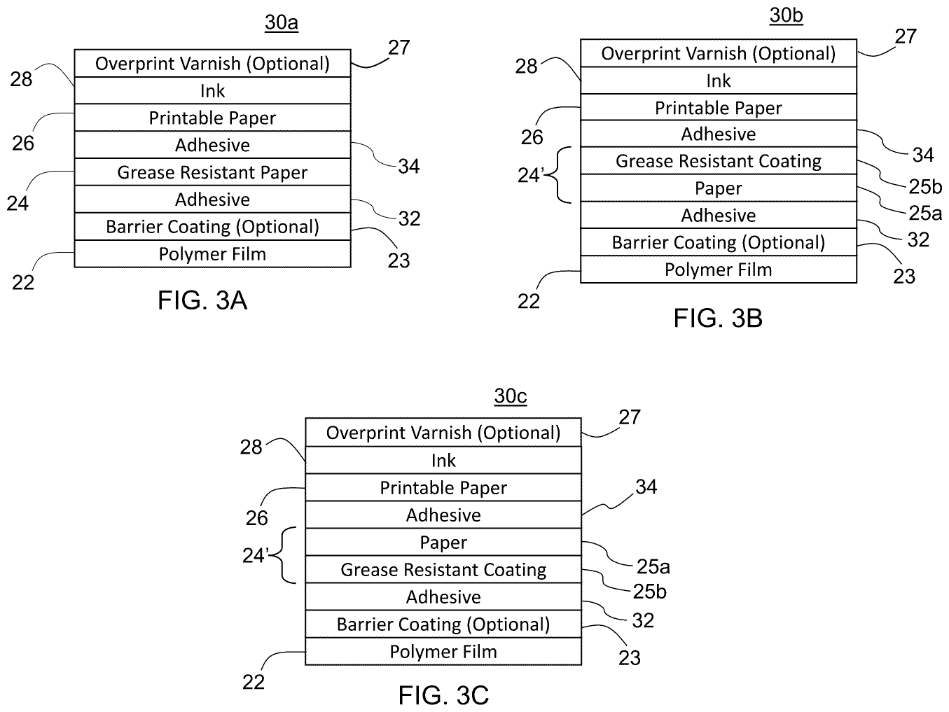

As shown in FIG. 3A, a multiwall structure 30a, which may be embodied as a continuous web of sheet material. The structure 30a comprises an inner polymer film ply 22, an intermediate grease-resistant paper ply 24, and an outer printable paper ply 26. A first adhesive layer 32 is disposed between the inner polymer film ply 22 and the intermediate paper layer 24. A second adhesive layer 34 is disposed between the grease-resistant paper layer 24 and the printable paper layer 26. An optional printed ink layer 28 is provided on the outward or exterior facing surface of the outer paper ply 26 to provide text, pictorial, or other graphical indicia or representations to appear on the exterior of the package construction 10. An optional varnish or lacquer overprint layer 27 is applied over the ink layer 28, e.g., to protect the ink layer 28 from scuffing and rubbing off and/or to provide a desired matte or gloss finish over the printed ink layer.

The inner polymer layer 22 serves as a moisture and/or oxygen barrier. The inner polymer layer 22 also acts as a barrier to prevent sharp objects or protrusions from puncturing or tearing through the packaging material. The strength and toughness of the inner polymer layer 22 help distribute forces exerted by impact or pressure to reduce the likelihood of punctures or tears. The strength and toughness of the inner polymer layer 22 also contribute to the overall durability of the packaging, enabling it to comply with certain drop test standards, e.g., drop test standards designed to ensure that the packaging can withstand mechanical stresses which may be encountered during distribution and handling.

In embodiments, the inner polymer film ply 22 is formed of a material such as polyolefin, polyester, or polyamide. The inner polymer film ply 22 may comprise a monolayer or multilayer structure. In certain embodiments, the inner polymer film ply 22 is formed of a monoaxially- or biaxially-oriented (stretched) film structure. In certain embodiments, the inner polymer film ply 22 includes one or more gas barrier layers, such as an oxygen and/or water vapor barrier layer. In certain embodiments, the inner polymer film ply 22 is formed of biaxially-oriented polypropylene (BOPP). In certain embodiments, the inner polymer film ply 22 is formed of cast polypropylene (CPP). In certain embodiments, the inner polymer film ply 22 is formed of polyethylene terephthalate (PET), polybutylene terephthalate (PBT), or a blend thereof. In certain embodiments, the inner polymer film ply 22 is formed of biaxially-oriented polyethylene terephthalate (BOPET). In certain embodiments, the inner polymer film ply 22 is formed of a polyamide, such as nylon 6, nylon 66, nylon 12, or nylon 6-12, including, monoaxially- and biaxially-oriented films of those films. In certain embodiments, the inner polymer film ply 22 is formed of polyethylene, such as such as low-density polyethylene (LDPE), very low-density polyethylene (VLDPE), linear low-density polyethylene (LLDPE), medium density polyethylene (MDPE), linear medium density polyethylene (LMDPE), high-density polyethylene (HDPE), metallocene polyethylene including metallocene linear low-density polyethylene (mLLDPE), polyolefin plastomer (POP), as well as blends and coextrusions of any of the foregoing,.

In embodiments, the inner polymer film ply has a gauge thickness in the range of about 20 gauge (ga) to about 150 ga, preferably about 48 ga to about 70 ga (1 ga=0.01 mil). In certain embodiments, the inner polymer film ply 22 is formed of a multilayer

polyolefin barrier film, preferably a coextruded polyolefin barrier film. In embodiments, the polyolefin barrier film includes a barrier layer formed of ethylene vinyl alcohol (EVOH), polyvinyl alcohol (PVOH), ethylene vinyl acetate copolymer (EVA), nylon (e.g., and nylon 6, nylon 6,6) the like. Exemplary polyolefins include polyethylene (PE) and polypropylene (PP).

In embodiments, the inner polymer film ply 22 has a multilayer structure as follows:
polyolefin/barrier/polyolefin
   where optional ties resin layers (“tie”) may be provided to promote adhesion between adjacent layers.

Examples of such multilayer structures include:

PE/EVOH/PE
PP/EVOH/PP
PE/tie/EVOH/tie/PE
PP/tie/EVOH/tie/PP
PE/nylon/PE
PP/nylon/PP
PE/tie/nylon/tie/PE
PP/tie/nylon/tie/PP
PE/nylon/EVOH/nylon/PE
PP/nylon/EVOH/nylon/PP
PE/tie/nylon/EVOH/nylon/tie/PE
PP/tie/nylon/EVOH/nylon/tie/PP
PE/nylon/tie/EVOH/tie/nylon/PE
PP/nylon/tie/EVOH/tie/nylon/PP
PE/tie/nylon/tie/EVOH/tie/nylon/tie/PE
PP/tie/nylon/tie/EVOH/tie/nylon/tie/PP

In embodiments, the inner polymer film ply 22 has a multilayer structure as follows:
polyolefin/polyolefin/barrier/polyolefin/polyolefin
   where optional ties resin layers (“tie”) may be provided to promote adhesion between adjacent layers.

Examples of such multilayer structures include:

PE/PE/EVOH/PE/PE
PE/PE/tie/EVOH/tie/PP/PP
PP/PP/EVOH/PP/PP
PP/PP/tie/EVOH/tie/PP/PP
PE/PE/nylon/PE/PE
PP/PP/nylon/PP/PP
PE/PE/tie/nylon/tie/PE/PE
PP/PP/tie/nylon/tie/PP/PP
PE/PE/nylon/EVOH/nylon/PE/PE
PP/PP/nylon/EVOH/nylon/PP/PP
PE/PE/tie/nylon/EVOH/nylon/tie/PE/PE
PP/PP/tie/nylon/EVOH/nylon/tie/PP/PP
PE/PE/nylon/tie/EVOH/tie/nylon/PE/PE
PP/PP/nylon/tie/EVOH/tie/nylon/PP/PP
PE/PE/tie/nylon/tie/EVOH/tie/nylon/tie/PE/PE
PP/PP/tie/nylon/tie/EVOH/tie/nylon/tie/PP/PP

In certain embodiments, the inner polymer film ply 22 is formed of a multilayer structure as follows:
cast polypropylene/barrier/cast polypropylene
   where optional ties resin layers (“tie”) may be provided to promote adhesion between adjacent layers and wherein the cast polypropylene (CPP) layers may be a monolayer or multilayer CPP structure.

Examples of such multilayer structures include:

CPP/EVOH/CPP
CPP/tie/EVOH/tie/CPP
CPP/nylon/CPP
CPP/tie/nylon/tie/CPP
CPP/nylon/EVOH/nylon/CPP
CPP/tie/nylon/EVOH/nylon/tie/CPP
CPP/nylon/tie/EVOH/tie/nylon/CPP
CPP/tie/nylon/tie/EVOH/tie/nylon/tie/CPP

In certain embodiments, the inner polymer film ply 22 is formed of any of the polymer materials described above in combination with an additional barrier coating layer 23. In embodiments, the barrier coating 23 is formed of an oxide barrier coating comprising a metal oxide, such as aluminum oxide (AlOx), silicon oxide (SiOx), titanium oxide (TiO₂), or a combination thereof. In embodiments, the barrier coating 23 is formed of a metal barrier coating comprising a metal such as aluminum (Al), copper (Cu), or silver (Ag), or a metal alloy. In embodiments, the metal coating or metal oxide coating is applied using a physical or chemical vapor deposition technique.

The grease-resistant paper ply 24 comprises a fluorochemical free paper. In embodiments, the grease-resistant paper ply 24 comprises a highly refined paper, e.g., similar to glassine paper, which imparts grease-resistance to the structure without fluorocarbon treatment. In such embodiments, the grease resistant properties of the ply 24 is the result of tight packing of the highly refined fibers of the sheet, thereby physically preventing the migration of grease into and through the ply 24. In embodiments, the grease-resistant paper ply 24 comprises a fluorochemical free paper which has a coating applied to enhance oil/grease resistance and edge wicking resistance. In certain embodiments, the grease-resistant paper ply 24 is a highly refined and calendared paper. In certain embodiments, the coating is a bio-based coating such as starches, sugar cane-based coatings and the like. In certain embodiments, the grease-resistant paper ply 24 is an extensible paper to provide improved puncture resistance and tensile strength. In certain embodiments, the grease-resistant paper ply 24 is a bleached Kraft paper or a natural Kraft paper.

In certain embodiments, the grease-resistant paper ply 24 is a commercially available grease resistant, PFAS-free paper, such as GREASE-GARD™ FLUOROFREE™ paper, which is available from Ahlstrom-Munksjö of Helsinki, Finland.

As an alternative to or in addition to the aforementioned oil/grease resistant coating layer, one or more oil and/or grease resistance additives may be added to the fibrous composition during the paper making process, for example, at levels up to about 2% by weight. Exemplary oil and/or grease resistance additives include, for example, oxidized polyethylenes, latex, styrene maleic anhydride (SMA), polyamide, waxes, alginate, proteins, carboxymethyl cellulose (CMC), hydroxyethyl cellulose (HMC), and so forth.

In embodiments, the grease-resistant paper layer 24 has a basis weight in the range of about 15#/ream to about 100#/ream, preferably about 40#/ream to about 60 #/ream (based on 3000 square foot ream).

The outer paper ply 26 may be suitable printable paper that is fluorochemical free. Exemplary types of printable paper suitable for the ply 26 include clay-coated paper (e.g., coated one side or C1S paper), bleached kraft paper, natural kraft paper, recycled paper, and the like.

In embodiments, the outer paper layer 26 has a basis weight in the range of about 15#/ream to about 100#/ream, preferably about 40#/ream to about 60#/ream (based on 3000 square foot ream).

The adhesive layers 32, 34, which may be the same or different, may be formed of any suitable adhesive for adhesively laminating the plies, including single component adhesives, two component adhesives, solvent-based adhesives, solventless adhesives, water-based adhesives, acrylic-based adhesives, extruded polyethylene or polypropylene adhesive systems, electron beam lamination adhesives, and UV lamination adhesives, pressure sensitive adhesives, styrene copolymer adhesives, rubber-based adhesives, and the like. In certain embodiments, pressure sensitive adhesives can advantageously be used to reduce the stiffness throughout the bag, but run the risk of adversely affecting the palatability testing for certain applications as would be understood by persons skilled in the art.

In embodiments, the ink layer 28 is a surface printed ink layer. In certain embodiments, the ink layer 28 is applied using solventless ink system, such as energy-cured inks (e.g., electron beam cured-inks or UV radiation-cured inks). In certain embodiments, the ink layer 28 is applied using water-based inks. In certain embodiments, an optional varnish or over lacquer layer 27 is applied to the ink layer 28 to protect the ink(s) from scuffs and rubbing off. In embodiments, the overprint varnish or lacquer also increases the strength of the bag, enhances oil and grease resistance, and/or improves moisture barrier properties of the bag.

In certain embodiments, solventless ink systems or water-based inks are utilized to prevent residual, unevaporated ink solvents from permeating the plies of the bag 10. For example, when utilizing the packaging constructions 10 herein for pet food applications, it has been found that when solvent free ink systems such as energy cured inks and water-based inks are used, there are minimal effects on palatability (PAL) testing with animals.

The printing ink layer 28 can be applied to the outer surface of the outer paper ply 26 via any conventional printing method as would be understood by persons skilled in the art, including without limitation, using a rotogravure printing apparatus, flexographic printing apparatus, offset printing apparatus, digital printing apparatus, ink jet printing apparatus, or the like.

Referring now to FIG. 3B, there is shown a second embodiment multilayer sheet material 30b which is as described above by way of reference to FIG. 3A, which description is incorporated here by reference, except that the grease resistant paper 24 having inherent grease resistance properties has been replaced with a grease-resistant composite 24′ comprising a paper layer 25a having a grease-resistant coating 25b disposed on the exterior facing surface of the paper layer 25a.

The paper layer 25a may be a coated paper, uncoated paper, bleached kraft paper, natural kraft paper, recycled paper, and the like. In embodiments, the paper layer 25a has a basis weight in the range of about 15#/ream to about 100#/ream, preferably about 40#/ream to about 60#/ream (based on 3000 square foot ream).

The coating layer 25b may be a polyolefin, e.g., polypropylene or polyethylene, or mixtures or blends thereof, SURLYN™, ethylene vinyl acetate (EVA), polyacrylates, such as ethylene acrylic acid (EAA), ethylene methyl acrylate (EMA), ethylene methyl methacrylate (EMMA), polyvinyl alcohol (PVOH), nylon, and polyolefin barrier coextrusions. In certain embodiments, the coating layer 25b may be applied as an extrusion coating or coextrusion coating layer.

In certain embodiments, the coating layer 25b is formed of a multilayer structure as follows:
polyolefin/barrier/polyolefin
   where optional ties resin layers (“tie”) may be provided to promote adhesion between adjacent layers.

Examples of such multilayer structures include:

PE/EVOH/PE
PP/EVOH/PP
PE/tie/EVOH/tie/PE
PP/tie/EVOH/tie/PP
PE/nylon/PE
PP/nylon/PP
PE/tie/nylon/tie/PE
PP/tie/nylon/tie/PP
PE/nylon/EVOH/nylon/PE
PP/nylon/EVOH/nylon/PP
PE/tie/nylon/EVOH/nylon/tie/PE
PP/tie/nylon/EVOH/nylon/tie/PP
PE/nylon/tie/EVOH/tie/nylon/PE
PP/nylon/tie/EVOH/tie/nylon/PP
PE/tie/nylon/tie/EVOH/tie/nylon/tie/PE
PP/tie/nylon/tie/EVOH/tie/nylon/tie/PP

In certain embodiments, the coating layer 25b is formed of a multilayer structure as follows:
barrier/polyolefin
   where the barrier layer is applied directly to the paper layer 25a and the polyolefin layer is disposed on the barrier layer. Optional ties resin layers (“tie”) may be provided to promote adhesion between adjacent layers.

Examples of such multilayer structures include:

EVOH/PE
EVOH/PP
EVOH/tie/PE
EVOH/tie/PP
nylon/PE
nylon/PP
nylon/tie/PE
nylon/tie/PP
nylon/EVOH/nylon/PE
nylon/EVOH/nylon/PP
nylon/EVOH/nylon/tie/PE
nylon/EVOH/nylon/tie/PP
nylon/tie/EVOH/nylon/PE
nylon/tie/EVOH/nylon/PP
nylon/tie/EVOH/nylon/tie/PE
nylon/tie/EVOH/nylon/tie/PP
nylon/EVOH/tie/nylon/PE
nylon/EVOH/tie/nylon/PP
nylon/EVOH/tie/nylon/tie/PE
nylon/EVOH/tie/nylon/tie/PP
nylon/tie/EVOH/tie/nylon/PE
nylon/tie/EVOH/tie/nylon/PP
nylon/tie/EVOH/tie/nylon/tie/PE
nylon/tie/EVOH/tie/nylon/tie/PP

In certain embodiments, the surface of the paper layer 25a that receives the grease resistant coating 25b is treated with a chemical primer to increase adhesion as would be understood by persons skilled in the art. In certain embodiments, the surface of the paper layer 25a that receives the grease resistant coating 25b is treated with a surface treatment to increase adhesion, such as flame treatment, corona treatment, plasma treatment, and ozone treatment.

In certain alternative embodiments, the coating layer 25b is applied to the paper layer 25a as a coating in the form of an aqueous or non-aqueous solvent-based polymer dispersion and then dried, wherein exemplary solvents include water, ethanol, and isopropanol. In such embodiments, the aqueous or non-aqueous solvent-based polymer dispersion is applied by a suitable coating technique, such as roll coating, roll-to-roll coating, various types of gravure coating, flexographic coating, bar coating, doctor blade coating, comma coating, spraying, or brush coating. The solvent is removed using heat, vacuum, forced hot air, drying oven, and the like.

Referring now to FIG. 3C, there is shown a second embodiment multilayer sheet material 30c which is as described above by way of reference to FIG. 3B, which description is incorporated here by reference, except that the grease-resistant composite layer 24′ has been inverted such that the grease-resistant coating 25b is facing toward the interior surface of the multilayer construction 30c.

In the manufacture of the packaging structure 30a, each of the plies 22, 24, and 26 are formed as separate webs which are adhesively laminated together to form the single, multi-ply web 30a. In the manufacture of the packaging structures 30b and 30c, each of the plies 22, 24′, and 26 are formed as separate webs which are adhesively laminated together to form the single, multi-ply web 30b and 30c, respectively.

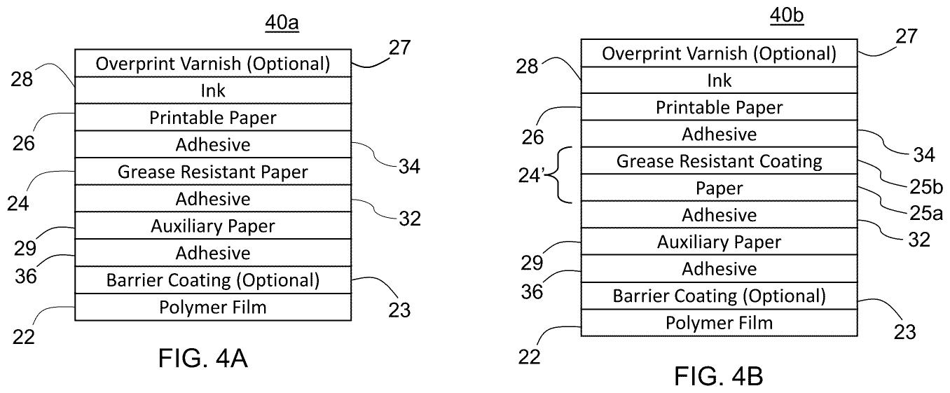

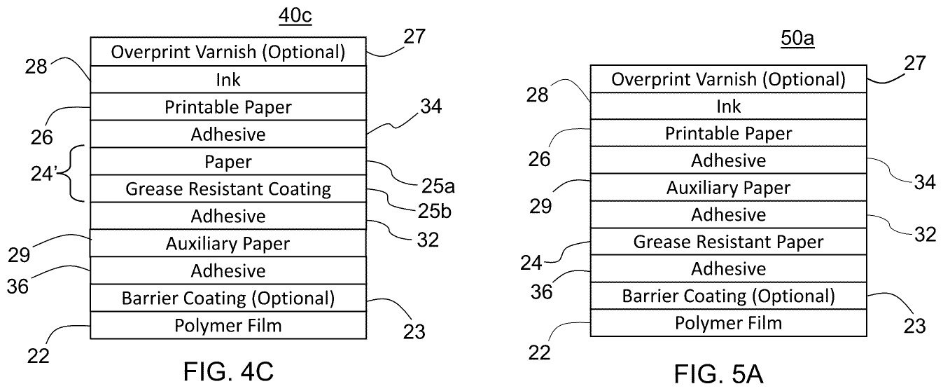

Referring now to FIG. 4A, there is shown a fourth embodiment multilayer sheet material 40a which is as described above by way of reference to FIG. 3A, which description is incorporated here by reference, except that an auxiliary paper layer 29 and third adhesive layer 36 are disposed intermediate the grease-resistant paper layer 24 and the polymer film layer 22. The auxiliary paper layer 29 may be a bleached or unbleached paper layer which contains no fluorochemical materials. In embodiments, the auxiliary paper layer 29 has a basis weight in the range of about 15#/ream to about 100#/ream, preferably about 40#/ream to about 60#/ream (based on 3000 square foot ream).

The adhesive layer 36 may be an adhesive as described above by way of reference to the adhesive layers 32 and 34. The auxiliary paper layer 29 increases the strength of the multiwall sheet 40a and also increases the cellulosic fiber content of the multiwall sheet 40a.

Referring now to FIG. 4B, there is shown a fifth embodiment multilayer sheet material 40b which is as described above by way of reference to FIG. 3B, which description is incorporated here by reference, except that an auxiliary paper layer 29 and third adhesive layer 36 are disposed intermediate the grease-resistant paper composite layer 24′ and the polymer film layer 22. The auxiliary paper layer 29 may be a bleached or unbleached paper layer which contains no fluorochemical materials. In embodiments, the auxiliary paper layer 29 has a basis weight in the range of about 15#/ream to about 100#/ream, preferably about 40#/ream to about 60#/ream (based on 3000 square foot ream).

The adhesive layer 36 may be an adhesive as described above by way of reference to the adhesive layers 32 and 34. The auxiliary paper layer 29 increases the strength of the multiwall sheet 40b and also increases the cellulosic fiber content of the multiwall sheet 40b.

Referring now to FIG. 4C, there is shown a sixth embodiment multilayer sheet material 40c which is as described above by way of reference to FIG. 3C, which description is incorporated here by reference, except that an auxiliary paper layer 29 and third adhesive layer 36 are disposed intermediate the grease-resistant paper composite layer 24′ and the polymer film layer 22. The auxiliary paper layer 29 may be a bleached or unbleached paper layer which contains no fluorochemical materials. In embodiments, the auxiliary paper layer 29 has a basis weight in the range of about 15#/ream to about 100#/ream, preferably about 40#/ream to about 60#/ream (based on 3000 square foot ream).

The adhesive layer 36 may be an adhesive as described above by way of reference to the adhesive layers 32 and 34. The auxiliary paper layer 29 increases the strength of the multiwall sheet 40c and also increases the cellulosic fiber content of the multiwall sheet 40c.

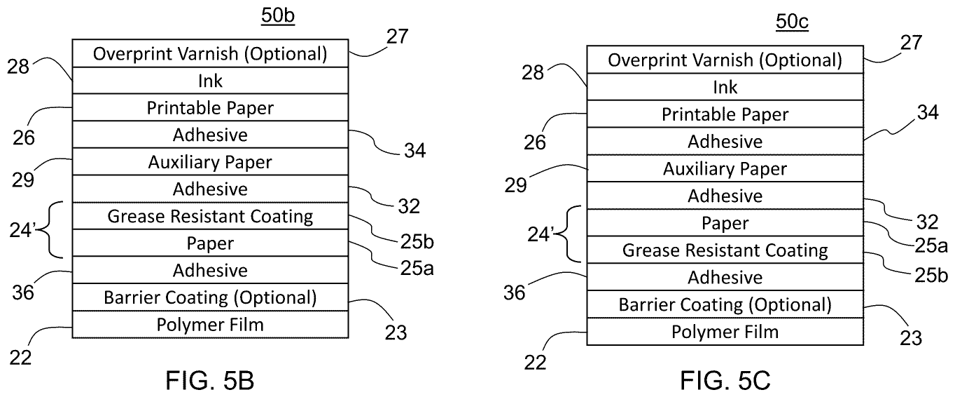

Referring now to FIG. 5A, there is shown a seventh embodiment multilayer sheet material 50a which is as described above by way of reference to FIG. 4A, which description is incorporated here by reference, except that the auxiliary paper layer 29 is disposed intermediate the grease resistant paper layer 24 and the printable paper layer 26.

Referring now to FIG. 5B, there is shown an eighth embodiment multilayer sheet material 50b which is as described above by way of reference to FIG. 4B, which description is incorporated here by reference, except that the auxiliary paper layer 29 is disposed intermediate the grease resistant paper layer composite 24′ and the printable paper layer 26.

Referring now to FIG. 5C, there is shown a ninth embodiment multilayer sheet material 50c which is as described above by way of reference to FIG. 4C, which description is incorporated here by reference, except that the auxiliary paper layer 29 is disposed intermediate the grease resistant paper layer composite 24′ and the printable paper layer 26.

In embodiments, the composition of the laminated packaging structures 30a-30c, 40a-40c, and 50a-50c is such that total weight of the cellulosic fiber based on the total weight of the multilayer structure is in the range of 80% to 99%. In embodiments, the composition of the laminated packaging structures 30a-30c, 40a-40c, and 50a-50c is such that total weight of the cellulosic fiber based on the total weight of the multilayer structure is in the range of 80% to 99%. In embodiments, the composition of the laminated packaging structures 30a-30c, 40a-40c, and 50a-50c is such that total weight of the cellulosic fiber based on the total weight of the multilayer structure at least 80%, e.g., about 80%, 81%, 82%, 83%, 84%, 85%, 86%, 87%, 88%, 89%, 90%, 91%, 92%, 93%, 94%, 97%, 98%, and 99%. In embodiments, the composition of the laminated packaging structures 30a-30c, 40a-40c, and 50a-50c is such that total weight of the cellulosic fiber based on the total weight of the multilayer structure in the range of 90% to 95%. In this manner, the composition of the laminated packaging structures 30a-30c, 40a-40c, and 50a-50c can be selected such that the overall composition does not exceed a maximum amount of plastics or non-paper components for a given standard or guideline for paper recyclability and/or repulpability.

In the manufacture of the bag construction 10, after the plies 22, 24, and 26 are adhesively laminated to form the multi-ply web 30a-30c, 40a-40c, and 50a-50c, the multi-ply is printed, cut, folded, and glued or sealed to form the bag 10. In certain embodiments, the bag 10 is formed using a hot melt adhesive although other adhesives can be used as well, including the adhesives described above for gluing the plies.

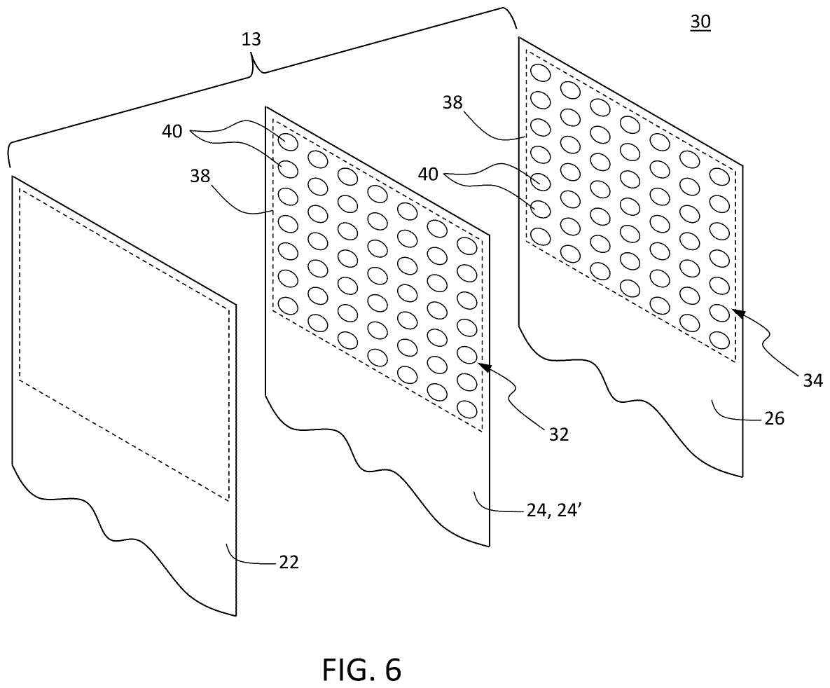

Referring now to FIG. 6, there appears an exploded view of the rear panel 13 of a three ply bag structure 30, shown in fragmentary view for ease of exposition, which may be one of the structures 30, 30b, or 30c as described above by way of reference to FIGS. 3A-3C, respectively. The adhesive layers 32, 34 are disposed within a predetermined adhesive region 38 as depicted in broken lines. Other positions or geometric configurations of the adhesive region 38 are also contemplated. In certain embodiments, a similar adhesive region is optionally disposed between the plies of the front panel 12 and, if present, the description herein is equally applicable thereto.

The adhesive layers 32, 34 appearing in FIG. 6 have a plurality of glue spots/adhesive spots 44 applied in a conventional grid pattern comprising a plurality of laterally directed rows and a plurality of axially directed columns. Such conventional grid pattern may be utilized in a typical multiwall bag having single adhesive layer, such as multiwall bag comprising a polymer inner liner which is fully laminated to an intermediate paper layer and which, in turn, is adhesively laminated to an outer paper layer. In the illustrated embodiment, the adhesive dot grid pattern comprises 7 transversely directed rows and 7 axially directed columns. It will be recognized that the depicted glue adhesive grid pattern of 7 columns by 7 rows and the size of the dots depicted in the illustrations are exemplary and are presented for illustrative purposes only and should not be construed as limiting the scope of the invention. It is understood that the invention can be practiced with grid patterns of varying dimensions, including but not limited to different numbers of columns and rows, as well as dots of various sizes. The specific configuration depicted is provided solely for illustrative purposes and should not restrict the interpretation or implementation of the invention.

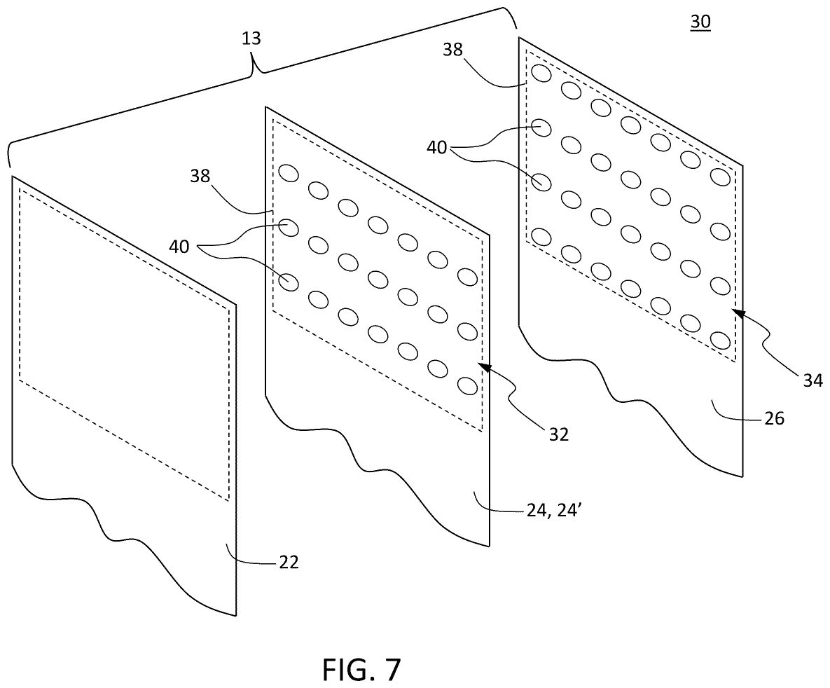

Referring now to FIG. 7-9, there appears bag construction embodiments, depicted generally as 30, having overlapping and coextensive adhesive layers 32, 34 in the adhesive region 38 on the rear panel 13. In order to reduce the stiffness caused by the two overlapping adhesive layers in the regions 38, the present development utilizes staggered grid patterns in the adhesive layers 32, 34. That is, a first glue spot pattern comprising a plurality of adhesive spots 40 in the adhesive layer 32 and a second glue spot pattern comprising a plurality of adhesive spots 40 of the adhesive layer 34 are configured such that the individual glue spots of the adhesive layer 32 do not overlap with or overlie the individual glue spots of the adhesive layer 34. In embodiments, the adhesive spot patterns comprise grids wherein the adhesive dots of one adhesive later are aligned with interstices of the other grid pattern and vice versa.

Referring now to FIG. 7, the first adhesive layer 32 in the region 38 and the second adhesive layer 34 in the region 38 each utilize adhesive dot patterns wherein the adhesive dots of each of the first and second adhesive layers 32, 34 are spaced and arranged in rows directed in a first direction and columns directed in a second direction orthogonal to the first direction, wherein the rows of the first adhesive layer grid pattern and the rows of the second adhesive layer grid pattern are mutually offset in the first direction.

In embodiments, the first adhesive layer 32 in the region 38 and the second adhesive layer 34 in the region 38 each utilize adhesive dot patterns wherein the adhesive dots of each of the first and second adhesive layers 32, 34 are spaced and arranged in laterally directed rows and axially directed columns, wherein the rows of the first adhesive layer and the rows of the second adhesive layer are mutually offset axially.

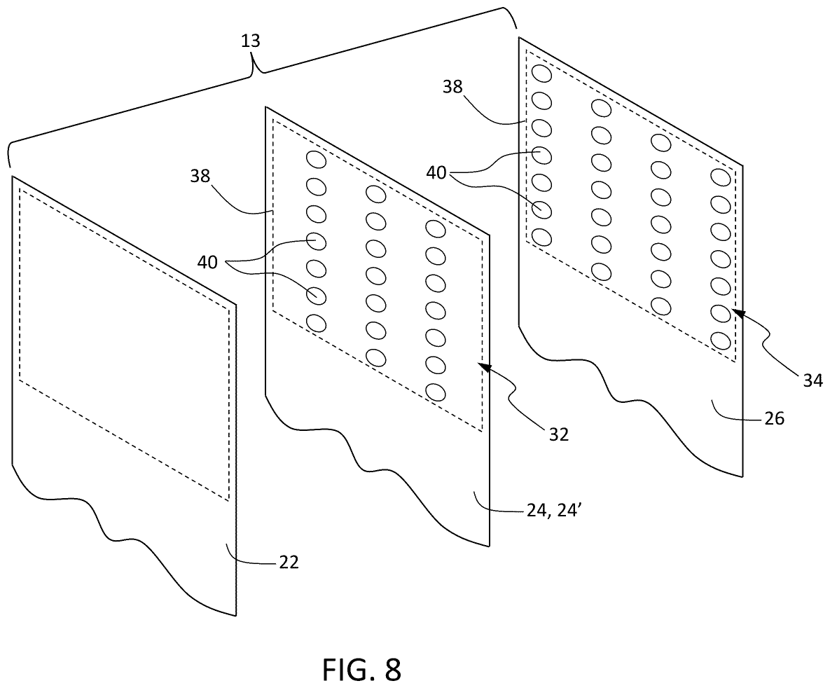

Referring now to FIG. 8, the first adhesive layer 32 in the region 38 and the second adhesive layer 34 in the region 38 each utilize adhesive dot patterns wherein the adhesive dots of each of the first and second adhesive layers 32, 34 are spaced and arranged in rows directed in a first direction and columns directed in a second direction orthogonal to the first direction, wherein the columns of the first adhesive layer grid pattern and the columns of the second adhesive layer grid pattern are mutually offset in the second direction.

In embodiments, the first adhesive layer 32 in the region 38 and the second adhesive layer 34 in the region 38 each utilize adhesive dot patterns wherein the adhesive dots of each of the first and second adhesive layers 32, 34 are spaced and arranged in laterally directed rows and axially directed columns, wherein the columns of the first adhesive layer and the columns of the second adhesive layer are mutually offset laterally.

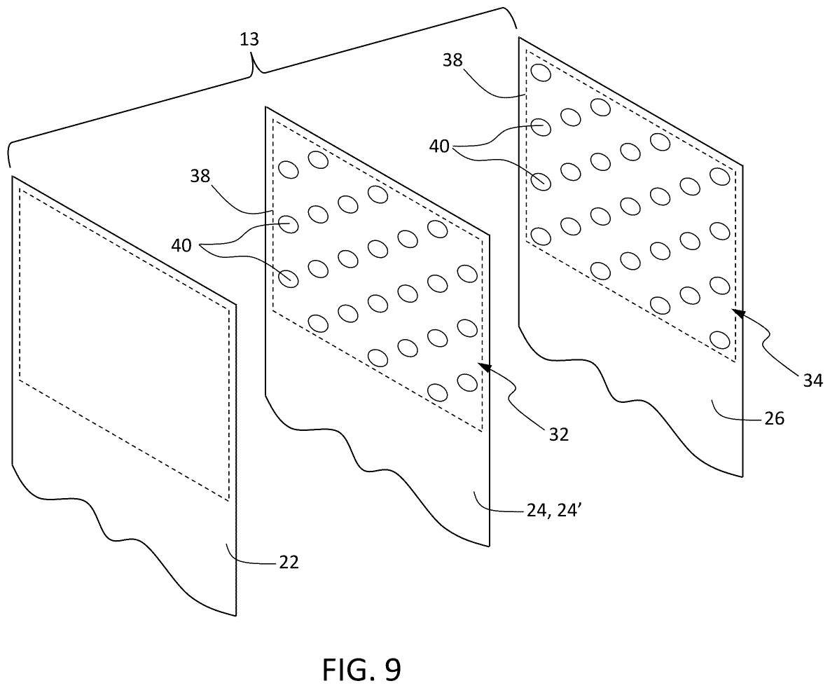

Referring now to FIG. 9, the first adhesive layer 32 in the region 38 and the second adhesive layer 34 in the region 38 each utilize adhesive dot patterns wherein the adhesive dots of each of the first and second adhesive layers 32, 34 are spaced and arranged in rows directed in a first direction and columns directed in a second direction orthogonal to the first direction, wherein the rows of the first adhesive layer grid pattern and the rows of the second adhesive layer grid pattern are mutually offset in the first direction, and wherein the columns of the first adhesive layer grid pattern and the columns of the second adhesive layer grid pattern are mutually offset in the second direction.

In embodiments, the first adhesive layer 32 in the region 38 and the second adhesive layer 34 in the region 38 each utilize adhesive dot patterns wherein the adhesive dots of each of the first and second adhesive layers 32, 34 are spaced and arranged in laterally directed rows and axially directed columns, wherein the rows of the first adhesive layer and the rows of the second adhesive layer are mutually offset axially, and wherein the columns of the first adhesive layer and the columns of the second adhesive layer are mutually offset laterally.

Since the glue spots within the first adhesive layer 32 are aligned with the interstices within the second adhesive layer 34 and vice versa, there will be no point within the adhesive region 38 where glue spots in the first adhesive layer 32 overlap with glue spots in the second adhesive layer 34, thereby reducing the stiffness of the bag construction 10.

The staggered glue dot patterns appearing in FIGS. 7-9 can likewise be adapted for use with the 4-ply embodiments appearing in FIGS. 4A-4C and 5A-5C to reduce stiffness. In embodiments, the grid patterns appearing in the adhesive region 38 of the adhesive layers 32, 34, 36 are each staggered the individual glue spots of each adhesive layer 32, 34, 36 do not overlap with or overlie the individual glue spots of any adjacent adhesive layer. In further embodiments, the grid patterns appearing in the adhesive region 38 of the adhesive layers 32, 34, 36 are each staggered the individual glue spots of each adhesive layer 32, 34, 36 do not overlap with or overlie the individual glue spots of any of the other adhesive layer.

In embodiments, the glue spots of each of the first, second, and third adhesive layers 32, 34, 36, respectively, are spaced and arranged in rows directed in a first direction and columns directed in a second direction orthogonal to the first direction, wherein the rows in adjacent adhesive layers are mutually offset in the first direction.

In embodiments, the glue spots of each of the first, second, and third adhesive layers 32, 34, 36, respectively, are spaced and arranged in laterally directed rows and axially directed columns, wherein the rows in adjacent adhesive layers are mutually offset in the axially.

In embodiments, the glue spots of each of the first, second, and third adhesive layers 32, 34, 36, respectively, are spaced and arranged in rows directed in a first direction and columns directed in a second direction orthogonal to the first direction, the columns in adjacent adhesive layers are mutually offset in the second direction.

In embodiments, the glue spots of each of the first, second, and third adhesive layers 32, 34, 36, respectively, are spaced and arranged in laterally directed rows and axially directed columns, wherein the columns in adjacent adhesive layers are mutually offset laterally.

In embodiments, the glue spots of each of the first, second, and third adhesive layers 32, 34, 36, respectively, are spaced and arranged in rows directed in a first direction and columns directed in a second direction orthogonal to the first direction, wherein the rows in adjacent adhesive layers are mutually offset in the first direction, and wherein the columns in adjacent adhesive layers are mutually offset in the second direction.

In embodiments, the glue spots of each of the first, second, and third adhesive layers 32, 34, 36, respectively, are spaced and arranged in laterally directed rows and axially directed columns, wherein the rows in adjacent adhesive layers are mutually offset axially, and wherein the columns in adjacent adhesive layers are mutually offset laterally.

In embodiments, the glue spots of each of the first, second, and third adhesive layers 32, 34, 36, respectively, are spaced and arranged in rows directed in a first direction and columns directed in a second direction orthogonal to the first direction, wherein the rows in the adhesive layers 32, 34, 36 are mutually offset in the first direction.

In embodiments, the glue spots of each of the first, second, and third adhesive layers 32, 34, 36, respectively, are spaced and arranged in laterally directed rows and axially directed columns, wherein the rows in the adhesive layers 32, 34, 36 are mutually offset axially.

In embodiments, the glue spots of each of the first, second, and third adhesive layers 32, 34, 36, respectively, are spaced and arranged in rows directed in a first direction and columns directed in a second direction orthogonal to the first direction, the columns in the adhesive layers 32, 34, 36 are mutually offset in the second direction.

In embodiments, the glue spots of each of the first, second, and third adhesive layers 32, 34, 36, respectively, are spaced and arranged in laterally directed rows and axially directed columns, wherein the columns in the adhesive layers 32, 34, 36 are mutually offset laterally.

In embodiments, the glue spots of each of the first, second, and third adhesive layers 32, 34, 36, respectively, are spaced and arranged in rows directed in a first direction and columns directed in a second direction orthogonal to the first direction, wherein the rows in the adhesive layers 32, 34, 36 are mutually offset in the first direction, and wherein the columns in the adhesive layers 32, 34, 36 are mutually offset in the second direction.

In embodiments, the glue spots of each of the first, second, and third adhesive layers 32, 34, 36, respectively, are spaced and arranged in laterally directed rows and axially directed columns, wherein the rows in the adhesive layers 32, 34, 36 are mutually offset axially, and wherein the columns in the adhesive layers 32, 34, 36 are mutually offset laterally.

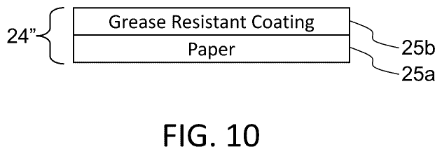

Referring now to FIG. 10, there is shown the coated paper substrate 24″ comprising a paper substrate 25a and a coating layer 25b. In embodiments, the coated paper substrate 24″ may be as described above by way of reference to the coated paper ply 24′, provided, however, that the overall composition of the coated paper substrate 24″ comprises at least 80% paper, by weight, e.g., 80-99%, e.g., 80%, 81%, 82%, 83%, 84%, 85%, 86%, 87%, 88%, 89%, 90%, 91%, 92%, 93%, 94%, 95%, 96%, 97%, 98%, or 99%, by weight.

The coated paper substrate 24″ finds use as a paper grade packaging material and is advantageously used for applications that can benefit from enhanced grease barrier properties, such as for butter wraps, food packaging liners, such as such as pizza box liners, fast food wraps, bags, wraps, and liners for bakery item, and the like, or any other packaging in need of grease barrier properties.

In certain embodiments, the coated paper substrate 24″ is formed of a multilayer structure as follows:
paper/barrier/polyolefin
   where the barrier layer is applied directly to the paper layer 25a and the polyolefin layer is disposed on the barrier layer. Optional ties resin layers (“tie”) may be provided to promote adhesion between adjacent layers. Preferably, the paper layer 25a is an extensible layer having a stretch characteristic. Optionally, the surface of the paper to which the barrier is applied is treated with a surface treatment to promote adhesion. Examples of such surface treatment include chemical primers, flame treatment, corona treatment, plasma treatment, and ozone treatment.

Examples of such coated paper substrates 24″ include:

paper/EVOH/PE
paper/EVOH/PP
paper/EVOH/tie/PE
paper/EVOH/tie/PP
paper/nylon/PE
paper/nylon/PP
paper/nylon/tie/PE
paper/nylon/tie/PP
paper/nylon/EVOH/nylon/PE
paper/nylon/EVOH/nylon/PP
paper/nylon/EVOH/nylon/tie/PE
paper/nylon/EVOH/nylon/tie/PP
paper/nylon/tie/EVOH/nylon/PE
paper/nylon/tie/EVOH/nylon/PP
paper/nylon/tie/EVOH/nylon/tie/PE
paper/nylon/tie/EVOH/nylon/tie/PP
paper/nylon/EVOH/tie/nylon/PE
paper/nylon/EVOH/tie/nylon/PP
paper/nylon/EVOH/tie/nylon/tie/PE
paper/nylon/EVOH/tie/nylon/tie/PP
paper/nylon/tie/EVOH/tie/nylon/PE
paper/nylon/tie/EVOH/tie/nylon/PP
paper/nylon/tie/EVOH/tie/nylon/tie/PE
paper/nylon/tie/EVOH/tie/nylon/tie/PP

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

1-61. (canceled)

62. A paper-based packaging structure, comprising:
an outer paper ply;
a first intermediate paper ply;
an inner polymer film ply;
a first adhesive layer disposed between the inner polymer film ply and the intermediate paper ply, the first adhesive layer securing the inner polymer film ply to the intermediate paper ply;
a second adhesive layer disposed between the intermediate paper ply and the outer paper ply, the second adhesive layer securing the intermediate paper ply to the outer paper ply;
wherein the outer paper ply, the intermediate paper ply, and the inner polymer film ply are adjoined to form a multiwall structure; and
wherein the paper-based packaging structure comprises cellulosic fiber in the range of from about 80% to about 99% by weight.

63. The paper-based packaging structure of claim 62, further comprising an inorganic barrier coating disposed on a surface of the inner polymer film ply.

64. The paper-based packaging structure of claim 62, wherein the inner polymer film ply comprises an organic barrier layer.

65. The paper-based packaging structure of claim 62, wherein the outer paper ply is formed of a printable paper and the first intermediate paper ply is formed of a grease-resistant paper.

66. The paper-based packaging structure of claim 65, wherein the first intermediate paper ply is formed of a material selected from the group consisting of:
a highly refined paper which is inherently grease resistant;
a paper having a grease resistant coating disposed on at least one surface thereof; and
a paper having a grease resistant additive blended into the paper.

67. The paper-based packaging structure of claim 62, further comprising:
a second intermediate paper ply disposed intermediate the inner polymer film ply and the first intermediate paper ply; and
a third adhesive layer disposed intermediate the second intermediate paper ply and the inner polymer film ply.

68. The paper-based packaging structure of claim 67, wherein the first, second, and third adhesive layers are coaligned on the multiwall structure, and wherein the first adhesive layer comprises a first plurality of adhesive spots, the second adhesive layer comprises a second plurality of adhesive spots, and the third adhesive layer comprises a third plurality of adhesive spots, wherein the adhesive spots of the first, second, and third pluralities of adhesive spots do not overlap with the adhesive spots of an adjacent one of the first, second, and third pluralities of adhesive spots.

69. The paper-based packaging structure of claim 68, wherein the adhesive spots of each of the first, second, and third adhesive layers, respectively, are spaced and arranged in rows directed in a first direction and columns directed in a second direction orthogonal to the first direction, and wherein the rows in adjacent adhesive layers are mutually offset in the first direction.

70. The paper-based packaging structure of claim 68, wherein the adhesive spots of each of the first, second, and third adhesive layers, respectively, are spaced and arranged in laterally directed rows and axially directed columns, and wherein the rows in adjacent adhesive layers are mutually offset axially.

71. The paper-based packaging structure of claim 68, wherein the adhesive spots of each of the first, second, and third adhesive layers, respectively, are spaced and arranged in rows directed in a first direction and columns directed in a second direction orthogonal to the first direction, and wherein the columns in adjacent adhesive layers are mutually offset in the second direction.

72. The paper-based packaging structure of claim 68, wherein, the adhesive spots of each of the first, second, and third adhesive layers, respectively, are spaced and arranged in laterally directed rows and axially directed columns, and wherein the columns in adjacent adhesive layers are mutually offset laterally.

73. The paper-based packaging structure of claim 68, wherein the adhesive spots of each of the first, second, and third adhesive layers, respectively, are spaced and arranged in rows directed in a first direction and columns directed in a second direction orthogonal to the first direction, and wherein the rows in adjacent adhesive layers are mutually offset in the first direction, and wherein the columns in adjacent adhesive layers are mutually offset in the second direction.

74. The paper-based packaging structure of claim 68, wherein the adhesive spots of each of the first, second, and third adhesive layers, respectively, are spaced and arranged in laterally directed rows and axially directed columns, wherein the rows in adjacent adhesive layers are mutually offset axially, and wherein the columns in adjacent adhesive layers are mutually offset laterally.

75. The paper-based packaging structure of claim 67, wherein the first, second, and third adhesive layers are coaligned on the multiwall structure, and wherein the first adhesive layer comprises a first plurality of adhesive spots, the second adhesive layer comprises a second plurality of adhesive spots, and the third adhesive layer comprises a third plurality of adhesive spots, wherein the adhesive spots of the first, second, and third pluralities of adhesive spots do not overlap with the adhesive spots of the other ones of the first, second, and third pluralities of adhesive spots.

76. The paper-based packaging structure of claim 75, wherein, the adhesive spots of each of the first, second, and third adhesive layers, respectively, are spaced and arranged in rows directed in a first direction and columns directed in a second direction orthogonal to the first direction, and wherein the rows in the first, second, and third adhesive layers are mutually offset in the first direction.

77. The paper-based packaging structure of claim 75, wherein the adhesive spots of each of the first, second, and third adhesive layers, respectively, are spaced and arranged in laterally directed rows and axially directed columns, and wherein the rows in the first, second, and third adhesive layers are mutually offset axially.

78. The paper-based packaging structure of claim 75, wherein the adhesive spots of each of the first, second, and third adhesive layers, respectively, are spaced and arranged in rows directed in a first direction and columns directed in a second direction orthogonal to the first direction, and wherein the columns in the first, second, and third adhesive layers are mutually offset in the second direction.

79. The paper-based packaging structure of claim 75, wherein the adhesive spots of each of the first, second, and third adhesive layers, respectively, are spaced and arranged in laterally directed rows and axially directed columns, and wherein the columns in the first, second, and third adhesive layers are mutually offset laterally.

80. The paper-based packaging structure of claim 75, wherein the adhesive spots of each of the first, second, and third adhesive layers, respectively, are spaced and arranged in rows directed in a first direction and columns directed in a second direction orthogonal to the first direction, and wherein the rows in the first, second, and third adhesive layers are mutually offset in the first direction, and wherein the columns in the first, second, and third adhesive layers are mutually offset in the second direction.

81. The paper-based packaging structure of claim 75, wherein the adhesive spots of each of the first, second, and third adhesive layers, respectively, are spaced and arranged in laterally directed rows and axially directed columns, wherein the rows in the first, second, and third adhesive layers are mutually offset axially, and wherein the columns in the first, second, and third adhesive layers are mutually offset laterally.

82. The paper-based packaging structure of claim 67, wherein the outer paper ply is formed of a printable paper and the first intermediate paper ply is formed of a grease-resistant paper.

83. The paper-based packaging structure of claim 82, wherein the first intermediate paper ply is formed of a material selected from the group consisting of:
a highly refined paper which is inherently grease resistant;
a paper having a grease resistant coating disposed on at least one surface thereof; and
a paper having a grease resistant additive blended into the paper.

84. The paper-based packaging structure of claim 62, further comprising:
a second intermediate paper ply disposed intermediate the outer paper ply and the first intermediate paper ply; and
a third adhesive layer disposed intermediate the first intermediate paper ply and the second intermediate paper ply.

85. The paper-based packaging structure of claim 84, wherein the outer paper ply is formed of a printable paper and the first intermediate paper ply is formed of a grease-resistant paper.

86. The paper-based packaging structure of claim 85, wherein the first intermediate paper ply is formed of a material selected from the group consisting of:
a highly refined paper which is inherently grease resistant;
a paper having a grease resistant coating disposed on at least one surface thereof; and
a paper having a grease resistant additive blended into the paper.

87. The paper-based packaging structure of claim 62, wherein the inner polymer film ply is selected from the group consisting of a polyolefin-based polymer film, a polyester-based polymer film, and a polyamide-based polymer film.

88. The paper-based packaging structure of claim 62, further comprising:
a printed ink layer disposed on an outward facing surface of the outer paper ply, wherein the printed ink layer is selected from the group consisting of a solvent-free ink, energy-cured ink, water-based ink, a solvent-based ink, an electron beam-cured ink, and a UV-cured ink; and
an optional overprint varnish or lacquer disposed on the printed ink layer.

89. The paper-based packaging structure of claim 62, wherein the first adhesive layer and the second adhesive layer are coaligned on the multiwall structure and wherein the first adhesive layer comprises a first plurality of adhesive spots and the second adhesive layer comprises a second plurality of adhesive spots, wherein the adhesive spots of the first plurality of adhesive spots do not overlap with the adhesive spots of the second plurality of adhesive spots and wherein each of the first plurality of adhesive spots and the second plurality of adhesive spots are spaced and arranged in a configuration selected from the group consisting of:
rows directed in a first direction and columns directed in a second direction orthogonal to the first direction, the rows of the first adhesive layer and the rows of the second adhesive layer being mutually offset in the first direction;
laterally directed rows and axially directed columns, the rows of the first adhesive layer and the rows of the second adhesive layer being mutually offset axially;
rows directed in a first direction and columns directed in a second direction orthogonal to the first direction, the columns of the first adhesive layer and the columns of the second adhesive layer being mutually offset in the second direction;
laterally directed rows and axially directed columns, the columns of the first adhesive layer and the columns of the second adhesive layer being mutually offset laterally;
rows directed in a first direction and columns directed in a second direction orthogonal to the first direction, the rows of the first adhesive layer and the rows of the second adhesive layer being mutually offset in the first direction, and the columns of the first adhesive layer and the columns of the second adhesive layer being mutually offset in the second direction; and
laterally directed rows and axially directed columns, the rows of the first adhesive layer and the rows of the second adhesive layer being mutually offset axially, and the columns of the first adhesive layer and the columns of the second adhesive layer being mutually offset laterally.

90. A packaging article comprising the paper-based packaging structure of claim 62, wherein the packaging article is selected from the group consisting of a bag, a pinch bottom open mouth (PBOM) bag, and a pet food bag.

91. A method of forming a packaging structure, comprising the steps of:
providing an outer web formed of a printable paper material;
providing a first intermediate web formed of a grease-resistant paper material;
providing an inner web formed of a polymer film;
adhesively laminating the outer web to the intermediate web;
adhesively laminating the first intermediate web to the inner web;
optionally, providing a second intermediate web formed of paper material and, prior to adhesively laminating the first intermediate web to the inner web, adhesively laminating the second intermediate web between the first intermediate web and the inner web;
optionally, providing a second intermediate web formed of paper material and, prior to adhesively laminating the first intermediate web to the outer web, adhesively laminating the second intermediate web between the first intermediate web and the outer web;
optionally, folding the paper-based packaging structure to form a pair of opposing front and back panels, each having top and bottom ends and opposing sides extending between the top and bottom ends and securing the bottom ends of the front and back panels and opposing sides to form a bottom closure which closes the bottom end of the packaging article, optionally wherein the bottom closure is selected from the group consisting of a pinch bottom closure and a block bottom closure and optionally wherein the opposing sides are gusseted.

92. The paper-based packaging structure of claim 62, further comprising any one or more of:
the first intermediate paper ply comprising a grease resistant coating;
one or both of the outer paper ply and the first intermediate paper ply comprising an extensible paper;
the first intermediate paper ply comprising a grease resistant coating formed by extrusion coating;
one or more of the outer paper ply, the first intermediate paper ply, and the inner polymer film ply comprising a primer layer disposed on a surface thereof;
the first intermediate paper ply comprising a grease resistant coating comprising a polyolefin layer;
the first intermediate paper ply comprising a grease resistant coating comprising a barrier layer;
the first intermediate paper ply comprising a grease resistant coating comprising a barrier layer which comprises a barrier composition selected from the group consisting of EVOH, nylon, or a combination thereof; and
the first intermediate paper ply comprising a barrier layer which is extrusion coated or coextrusion coated directly onto the first intermediate paper ply without any intermediate lamination and without any adhesive layer.
